(19) United States
(12) Patent Application Publication
(10) Pub. No.: US 2005/0069160 A1
(43) Pub. Date: Mar. 31, 2005

(54) Hearing aid-style anti-stuttering device

(76) Inventor: Thomas David Kehoe, Boulder, CO (US)

Correspondence Address: Thomas David Kehoe, P.O. Box 7551, Boulder, CO, 80306-7551, US

(21) Appl. No.: 10/674,194

(22) Filed: Sep. 29, 2003

(51) Int. Cl. H04R 25/00

(52) U.S. Cl. 381/312; 381/326

(57) ABSTRACT

A hearing aid-style anti-stuttering device, with a throat microphone to pick up the user's voice while rejecting background noise, and an FM wireless transmitter from the throat microphone to the hearing aid-style anti-stuttering device; or bonded to a tooth in the user's mouth, with sound transmitted via the user's skull to his or her ears; and providing frequency compression to shift the user's voice to a lower frequency in the user's ear, while minimizing loss of audio signal due to the 200 Hz low-frequency cutoff inherent in hearing aids; or with octave-scale, acoustically transparent frequency shifting.

### FIELD OF THE INVENTION

The present invention relates to devices or techniques which treat stuttering, and more particularly to devices employing altered auditory feedback to treat stuttering.

### BACKGROUND OF THE INVENTION

A variety of hearing aid-style anti-stuttering devices are marketed. One of the most popular is called the SpeechEasy, marketed by Janus Development Corp., of Greenville, N.C., described in U.S. Pat. No. 5,961,443. Comments written on the “SpeechEasy Users Group Message Board” (http://seug.1hostplus.com/) provide insights into the device's benefits and deficiencies.

The most common complaint about the SpeechEasy is background noise. For example, user “cheathwo” wrote:
The worst problem is the background noise . . . . I can hear noises through my SpeechEasy that I can't hear at all through my other ear. (For example, I was lightly scratching an itch on my leg yesterday; I heard nothing through my normal ear, but I could hear the scratching through my SpeechEasy ear.) Due to the background noise problem, I find it impossible to wear the device in noisy environments, like restaurants or bars. It is like being in a wind tunnel or something—it's a buzzing whirl of confusion. Even wearing it while walking down the street is not always fun—sometimes noisy traffic or construction noise or a siren is so painful to the ear that I have to yank the device out immediately. Even the slam of a cash register drawer when I'm wearing the device can cause me to flinch. It's also really annoying to wear while listening to the radio or listening to music (which I always do in my car and do a lot at home) and annoying to wear while watching TV. So I find myself taking it out a lot.
   User “axewarrior20” wrote:
When I am watching TV or in the gym at school I can't hear myself speak. I can only hear everybody else. So I have to take out my SpeechEasy. I also can't hear myself during lunch and while in the mall or at the arcade. I would like for them to try to make a better noise attenuator so that I can at least hear a whisper of my voice for their next set of SpeechEasys . . . . I would also like it if they would make it so that when I leave the gym I don't have to worry about ringing in my ears from it being so loud.

The SpeechEasy uses an omnidirectional microphone, designed to pick up all sounds around the user. In contrast, other electronic anti-stuttering devices use headsets or throat microphones with noise-cancelling directional microphones. These microphones reject background noise, but headsets are conspicuous, and throat microphones use conspicuous, sometimes uncomfortable wires. A need exists for an inconspicuous, comfortable microphone that picks up the user's voice clearly while rejecting background noise.

Another problem with the SpeechEasy, and hearing aid-style anti-stuttering devices in general, is poor frequency response. Anyone who has shopped for a stereo knows that big speakers produce better bass than little speakers. Hearing aid speakers, properly called drivers, are tiny and produce no bass at all. This usually isn't a problem because most people lose only their high-frequency hearing. Hearing aids typically have a frequency range of 200 to 10,000 Hz, with peak volume close to 10,000 Hz.

In contrast, stuttering is primarily a disorder of vocal chord vibration, or phonation. Anti-stuttering devices have to reproduce the user's fundamental frequency of phonation. For adult men, this is around 125 Hz. In other words, hearing aids physically can't reproduce the fundamental frequencies of adult male voices (and 80% of adult stutterers are men). This lack of frequency response (i.e., poor sound) makes hearing aid-style anti-stuttering devices less effective than devices that use full-size, flat-frequency response headphones or earphones.

The SpeechEasy uses frequency-shifting auditory feedback (FAF) to reduce stuttering (FAF appears to correct an auditory processing abnormality in adult stutterers). FAF also solves the frequency response problem. The device can shift up 500, 1000, or 2000 Hz. These settings can shift a 125 Hz male voice up to 625 Hz (about two octaves), 1125 Hz (about three octaves), or 2125 Hz (about four octaves). The device produces these frequencies well. However, frequency shifting introduces several further problems.

First, the SpeechEasy uses frequency compression and expansion. On the 500 Hz upshift setting, the device shifts 125 Hz to 625 Hz, or more than two octaves; shifts 500 Hz to 1000 Hz, or one octave; shifts 1000 Hz to 1500 Hz, or a half-octave; etc. The frequency shifts become smaller as the incoming signal frequency increases. If the user were listening to an orchestra, every instrument would sound like a piccolo.

The SpeechEasy also has downshift settings at 500 Hz, 1000 Hz, and 2000 Hz. Because the device cuts off at 200 Hz, with a 500 Hz downshift it cuts off all incoming sound at 700 Hz; with a 1000 Hz downshift it cuts off incoming sounds at 1200 Hz; and with the 2000 Hz downshift it cuts off incoming sounds at 2200 Hz. The user hears less and less of his voice with each increased setting. If you were listening to an orchestra, you'd hear fewer and fewer instruments until only the piccolo was playing.

In contrast, frequency shifting on an octave scale sounds “acoustically transparent.” With a one-octave downshift, a 1000 Hz signal becomes 500 Hz, 500 Hz becomes 250 Hz, 250 Hz becomes 125 Hz, etc. E.g., you could listen to an orchestra and distinctively hear every instrument (although a violin would sound like a viola, a viola would sound like a cello, etc.). The need exists for an “acoustically transparent” hearing aid-style anti-stuttering device.

Another problem is that a frequency upshift induces the user to tense his vocal chords. Stuttering is a disorder of vocal chord overtension. Extended use of a frequency upshift appears to cause the SpeechEasy device to become less effective over time. For example, a SpeechEasy user posted a journal of his experiences (http://www.livejournal.com/users/nerdythewell/). On the first day he wrote that he was “95%” fluent. Four weeks later he wrote,
Yesterday afternoon all effects of the SpeechEasy has pretty much worn off, tried my damnedest to keep it working but just couldn't . . . it's kinda frustrating going from near perfect speech back to normal.

On the SpeechEasy Message Board, user “sonicflux” wrote:
I've had my SE for about six months now, and the effects mostly wore off about two weeks ago . . . . The funny thing is that I can actually feel it's not working when I put it in. There's no “comfort” factor now, if that makes any sense.

In contrast, a frequency downshift induces the user to relax his vocal chords. Over time, the user's speech improves, until the user no longer needs the device. The SpeechEasy has FAF downshift settings. However, as noted above, a SpeechEasy in downshift mode picks up little of the user's voice due to frequency expansion. The need exists for a frequency downshifting hearing aid-style anti-stuttering device that clearly reproduces the user's voice.

Each of the above noted methods and systems provide relief for individuals who stutter. Due to the limitations associated with each system, it has been determined that the need exists for an anti-stuttering device which produce clear, understandable audio reproduction, within the physical limitations of hearing aid technology.

### References Cited

U.S. patent Documents
U.S Pat. No. 5,961,443; Rastatter, et al.; Oct. 5, 1999; 600/23.

### BRIEF SUMMARY OF THE INVENTION

Generally speaking, in accordance with the Invention, a hearing aid-style anti-stuttering device is provided.

The first embodiment of the Invention uses a throat microphone with a radio transmitter to wireless transmit the user's voice to his or her hearing aid-style anti-stuttering device.

A second embodiment of the Invention bonds the device a tooth in the user's mouth, transmitting sound via the user's skull to his or her ear.

A third embodiment of the Invention compresses frequencies downward, reducing frequency shifting as it approaches 200 Hz.

A fourth embodiment of the Invention shifts frequencies up or down on an octave scale, making the device “acoustically invisible.”

Accordingly, it is an object of the invention to reduce stuttering.

It is another object of the invention to reject background sounds.

It is another object of the invention to be “acoustically transparent,” that is, to not impair the user's hearing.

It is another object of the invention to induce vocal chord relaxation.

It is another object of the invention to train fluent speech so that the user eventually no longer needs the device.

Still other objects and advantages of the invention will, in part, be obvious and will, in part, be apparent from the specification.

The invention accordingly comprises the features of construction, combinations of elements and arrangements of parts which will be exemplified in the constructions hereinafter set forth, and the scope of the invention will be indicated in the claims.

### BRIEF DESCRIPTION OF THE DRAWINGS

FIG. 1 shows an electronic schematic diagram of a frequency-shifting anti-stuttering device operating on an octave scale.

### DETAILED DESCRIPTION OF THE PREFERRED EMBODIMENTS

In the first configuration of the Invention, an Impact Dynamic Speech Re-Coding Hearing Aid, Model DSR13, made by AVR Communications Ltd., of Eden Prairie, Minn., is re-programmed for use as an anti-stuttering device instead of as a hearing aid. The Impact DSR13 is available in both behind-the-ear BTE and in-the-ear (ITE) versions. A completely-in-the-ear-canal (CIC) model should be available in the near future.

The Impact DSR13 has a built-in omnidirectional microphone. It also has an FM receiver for receiving sound from wireless microphone. A throat microphone, such as the Chattervox transdermal microphone, made by Connections Unlimited, of West Palm Beach, Fla., can be plugged into an FM transmitter, such as the Personal FM Listening System model PFM 350, made by Williams Sound Corp., of Eden Prairie, Minn. The throat microphone can be hidden under the user's shirt collar, and the PFM 350 worn on the user's belt. The Impact DSR13 hearing aid then picks up the user's voice clearly, without background noise, and without a wired connection between the microphone and hearing aid.

The FM transmitter could also be built into the throat microphone, eliminating all wires.

In a second configuration of the Invention, an Impact DSR13 or similar hearing aid, reprogrammed as a speech aid, is bonded to a tooth in the user's mouth. This picks up the user's voice clearly without picking up background sounds. Sound is transmitted through the user's skull to his or her ears, eliminating the need for earphones.

In a third configuration of the Invention, an Impact DSR13 is programmed for downward frequency compression. The Impact DSR13 divides the frequency spectrum into three zones. High frequencies can by shifted down on an octave scale. Medium frequencies can shifted down by a smaller increment (also on an octave scale). Sounds below 300 Hz aren't shifted at all. This configuration of the Invention programs the Impact DSR13 with the following settings:

TABLE 1

| | | |
|---|---|---|
| Source: | Microphone | Uses built-in microphone |
| AGC-I KP: | 68 | Input automatic gain control minimized. |
| AGC-I RT: | 0.7 | Input automatic gain control minimized. |
| AGC-O: | −14 | Output automatic gain control minimized. |
| +6 dB: | Disabled | Additional amplification disabled. |
| HPF: | 0 | High-pass filter disabled. |
| LPF: | 9 | Low-pass filter maximized. |
| FCVL: | 1.50 octave | High frequencies shifted down 1.5 octaves. |
| FCV: | Enabled | Middle frequencies shifted down 0.5 octaves. |
| DCB1: | 0 | Disables high-frequency boost. |
| DCB2: | 3 | Maximizes low-frequency boost. |
| Instrument/ | 16:70 | Prolongs sounds 70 ms. |
| Prolongation | | |
| Settings: | | |

This program minimizes amplification, putting the Impact DSR13's user-adjustable volume control into a comfortable range for individuals with normal hearing. It shifts high frequencies down 1.5 octaves and middle frequencies down 0.5 octaves. Lower frequencies (near 200 Hz) aren't shifted at all.

The result is maximum effect on the user's speech and minimum hearing impairment (i.e., “acoustically transparent”), within the frequency parameters of the hearing aid driver.

In a fourth configuration of the Invention, a Yamaha YSS222-D integrated circuit is used to shift frequencies as much as 1.8 octaves up or down, in 0.1-octave increments.

This digital signal processor has excellent sound quality and, with its octave-scale frequency-shifting, is “acoustically transparent” to the user. In other words, a half-octave pitch shift improves the user's speech yet doesn't reduce the user's ability to understand other people's speech or hear environmental sounds.

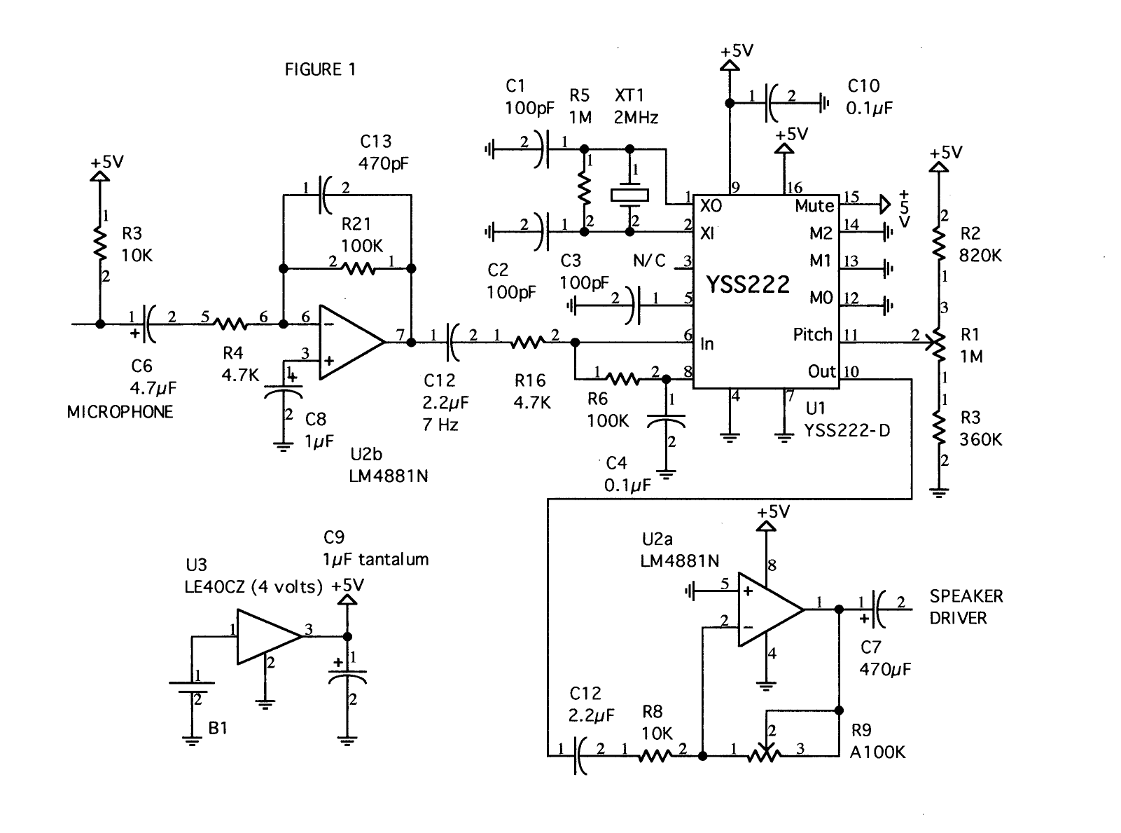

FIG. 1 teaches how to build a small, low-power electronic circuit using the YSS222-D, suitable for a hearing aid-style anti-stuttering device.

U.S. Pat. No. 5,961,443 describes an octave-scale hearing aid-style anti-stuttering device. However, that patent doesn't teach how to build such a device, and the inventors have not yet reduced to practice. The present Invention is the first to both describe and teach how to build an octave-scale hearing aid-style anti-stuttering device.

Thus, by utilizing the above construction, a hearing aid-style anti-stuttering device is realized.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative, and not in a limiting sense.

It will also be understood that the following claims are intended to cover all of the generic and specific features of the invention, herein described, and all statements of the scope of the invention which, as a matter of language, might be said to fall therebetween.

1. A microphone in contact with the user's throat, which transmits wirelessly to a receiver in contact with said user's ear.

2. A device according to claim 1, which picks up the user's voice and rejects environmental sounds.

3. A device according to claim 1, which transmits via frequency-modulated (FM) radio band.

4. A device for ameliorating stuttering supported by a tooth in a user's mouth, which transmits sound via said user's skull to said user's ears.

5. A device for ameliorating stuttering supported by an ear of an individual, said device comprising:
(a) a housing having opposing distal and proximal surfaces, wherein at least said proximal surface configured for positioning within an ear canal of said individual;
(b) a wave signal processor contained within said housing, said wave signal processor comprising:
(i) a receiver, said receiver generating an input signal responsive to an auditory signal associated with said individual's speech;
(ii) a downward frequency-compression auditory feedback circuit operably associated with said receiver for generating a downward frequency-compressed auditory signal; and
(iii) a transmitter contained within said housing and operably associated with said downward frequency-compressed auditory feedback circuit for transmitting said downward frequency-compressed auditory signal to said individual; and
(c) a power source operatively associated with said wave signal processor for supplying power thereto.

6. A device according to claim 5, wherein said downward frequency-compression auditory feedback circuit shifts higher frequencies more and lower frequencies less.

7. A device according to claim 5, wherein said frequency-compression auditory feedback circuit divides the audio signal into a plurality of frequency zones, each of which can be independently programmed to shift frequencies to different degrees.

8. A device according to claim 5, wherein said device is an in-the-ear (ITE) device.

9. A device according to claim 5, wherein said device is a completely-in-the-ear-canal (CIC) device.

10. A device for ameliorating stuttering supported by an ear of an individual, said device comprising:
(a) a housing having opposing distal and proximal surfaces, wherein at least said proximal surface configured for positioning within an ear canal of said individual;
(b) a wave signal processor contained within said housing, said wave signal processor comprising:
(i) a receiver, said receiver generating an input signal responsive to an auditory signal associated with said individual's speech;
(ii) an octave-scale frequency-shifting auditory feedback circuit operably associated with said receiver for generating an octave-scale frequency-shifting auditory signal; and
(iii) a transmitter contained within said housing and operably associated with said octave-scale frequency-shifting auditory feedback circuit for transmitting said octave-scale frequency-shifting auditory signal to said individual; and
(c) a power source operatively associated with said wave signal processor for supplying power thereto.

11. A device according to claim 10, wherein said device is an in-the-ear (ITE) device.

12. A device according to claim 10, wherein said device is a completely-in-the-ear-canal (CIC) device.

13. A device for ameliorating stuttering positioned behind the ear (BTE) of an individual, said device comprising:
(a) an ear mold having a portion adapted to be received into an ear of said individual;
(b) a housing in communication with said ear mold configured for positioning behind said ear of said individual;
(c) a receiver positioned adjacent said housing, said receiver generating an input signal responsive to an auditory signal associated with speech of said individual;
(d) a frequency-compressed auditory feedback circuit disposed in said housing and operatively associated with said receiver for generating a downward frequency-compressed auditory signal;
(e) a transmitter operably associated with said downward frequency-compressed auditory feedback circuit for transmitting the downward frequency-compressed auditory signal to the individual; and
(f) a power source operatively associated with said receiver, said downward frequency-compressed auditory feedback circuit, and said transmitter for supplying power thereto.

14. A device according to claim 13, wherein said frequency-compression auditory feedback circuit shifts higher frequencies more and lower frequencies less.

15. A device according to claim 13, wherein said frequency-compression auditory feedback circuit divides the audio signal into a plurality of frequency zones, each of which can be independently programmed to shift frequencies to different degrees.

16. A device according to claim 13, wherein said device is an ITE device.

17. A device according to claim 13, wherein said device is a CIC device.

18. A device for ameliorating stuttering positioned behind the ear (BTE) of an individual, said device comprising:
(a) an ear mold having a portion adapted to be received into an ear of said individual;
(b) a housing in communication with said ear mold configured for positioning behind an ear of said individual;
(c) a receiver positioned adjacent said housing, said receiver generating an input signal responsive to an auditory signal associated with speech of said individual;
(d) an octave-scale frequency-shifting auditory feedback circuit disposed in said housing and operatively associated with said receiver for generating an octave-scale frequency-shifting auditory signal;
(e) a transmitter operably associated with said octave-scale frequency-shifting auditory feedback circuit for transmitting said octave-scale frequency-shifting auditory signal to the individual; and
(f) a power source operatively associated with said receiver, said frequency-compressed auditory feedback circuit, and said transmitter for supplying power thereto.

19. A device according to claim 18, wherein said device is an ITE device.

20. A device according to claim 18, wherein said device is a CIC device.
